(19) United States
(12) Patent Application Publication
(10) Pub. No.: US 2005/0251850 A1
(43) Pub. Date: Nov. 10, 2005

(54) System and method for providing REA model based security

(75) Inventors: Jesper Kiehn, Valby (DK); Pavel Hruby, Naerum (DK); Geir Olsen, Wayzata, MN (US)

Correspondence Address: MICROSOFT CORPORATION C/O WESTMAN;CHAMPLIN & KELLY, P.A., SUITE 1400 - INTERNATIONAL CENTRE, 900 SECOND AVENUE SOUTH, MINNEAPOLIS, MN, 55402-3319, US

(73) Assignee: Microsoft Corporation, Redmond, WA (US)

(21) Appl. No.: 10/815,052

(22) Filed: Mar. 31, 2004

(51) Int. Cl. G06F 7/00; G06F 17/30

(52) U.S. Cl. 726/1

(57) ABSTRACT

A method of providing Resource-Event-Agent (REA) model based security includes identifying an association between a first object and a second object, where the first object is the Agent type and the second object is any REA object. Then, an association class is created for the association between the first object and the second object. The association class, for example called a Security Policy Association Class, defines security between the first object and the second object.

### BACKGROUND OF THE INVENTION

The present invention is related to Resource-Event-Agent (REA) models, and to systems and methods using an REA model. More particularly, the present invention is related to a method of providing security in REA models.

Business users and application developers prefer software applications where primary abstractions are the concepts that business people use to describe their work. For example, the concepts such as economic resources, business partners, contracts, and agreements are natural for business users, while the concepts such as classes, methods, virtual collections, and fields are natural for programmers, but not for business users.

The current trend towards model driven development is an attempt to move away from low level programming, towards modeling based on the concepts of the domain experts. Before one can do any modeling, regardless of whether this model is expressed in code or in a diagram, it is desirable to choose an ubiquitous language that can serve as the language for all people that work with this model. This language should stand the test of time during development and use of the software. An important aspect to ensuring that the language is reliable and comprehensive enough to fulfill these requirements is to base the language on a sound foundation. One modeling language which provides a sound foundation to address these needs is REA.

REA is the name of a prescriptive accounting model introduced by William E. McCarthy in 1982. See for example, William E. McCarthy, The REA Accounting Model: A Generalized Framework for Accounting Systems in a Shared Data Environment, The Accounting Review, Vol. LVII, No. 3, July 1982. REA is often referred to as a model, a framework, an ontology, an enterprise information system architecture, or by other commonly used names. The fundamental advantage of the REA model is that it provides a prescriptive model for describing a business's processes. Around the fundamental prescriptive model, a whole, infrastructure of additions have been added over the years in the form of more specifics on the modeling methodology itself, incorporation of REA in public standards, etc.

While REA allows for the modeling of “ownership” or “involvement”, it does not typically address security aspects of business models. Traditional business applications separate security specifics from the domain or business application modeling. Because of this there is very little to discover when it comes to Security configuration or Meta data and the security subsystem is often either missing or implemented in parallel to the application solution.

Prior solutions to security have typically been to let developers set up a list of properties that can or cannot be viewed by roles in the system. This approach is error prone. Further, this approach involves very complex implementations, frequently requiring several days per installation. Sometimes, this approach is implemented in software by the developer coding the solution. This makes it even more difficult to obtain the right security setup as the users (i.e., system administrators, etc) are not able to change the settings and define their own roles/security access.

### SUMMARY OF THE INVENTION

A method of providing Resource-Event-Agent (REA) model based security includes identifying an association between a first object and a second object in an REA model. Then, an association class is created for the association between the first object and the second object. The association class, for example called a Security Policy Association Class, defines security between the first object and the second object.

The association class, defined between the first object and the second object, is an object having properties. The properties of the association class object define the security between the first object and the second object. The step of creating the association class can further comprise creating one or more association class objects having properties, with the properties of the one or more association class objects defining security between a first class of objects of which the first object is a member and a second class of objects of which the second object is a member. The second object is a securable object, such as a contract or agreement type object, a commitment type object, an event type object, or a resource type object. The first object is of a particular agent type. A role for a user is defined by the particular agent type for the first object.

The association class created between the first object and the second object can be created in a security model either separate from the REA model, or as part of the REA model. The security defined between the first object and the second object includes defining permissions and rights of the first object relative to the second object. These permissions and rights can be determined dynamically in a security policy logic module outside of the security model. This is particularly useful for permissions and rights which are transient in nature, for example depending upon the date, time, status of an event, etc.

Other features and benefits that characterize embodiments of the present invention will be apparent upon reading the following detailed description and review of the associated drawings.

### BRIEF DESCRIPTION OF THE DRAWINGS

FIG. 1 is a block diagram of one exemplary environment in which the present invention can be implemented.

FIG. 2 is a block diagram of a general mobile computing environment in which the present invention can be implemented.

FIG. 3 is a block diagram illustrating the basic REA exchange pattern.

FIG. 4 is a block diagram schematically illustrating a semantic REA model with major object types and association types shown.

FIG. 5-1 is a block diagram illustrating an internal participation association between two classes of objects in accordance with a conventional REA model.

FIG. 5-2 is a block diagram illustrating an internal participation association between the two classes of objects shown in FIG. 4-1, with an association class added in accordance with the present invention to provide security aspects to the model.

FIG. 6-1 is a block diagram illustrating an external participation association between two classes of objects in accordance with a conventional REA model.

FIG. 6-2 is a block diagram illustrating an external participation association between the two classes of objects shown in FIG. 4-1, with an association class added in accordance with the present invention to provide security aspects to the model.

FIG. 7 is a block diagram illustrating further aspects of the present invention.

FIG. 8-1 is a block diagram illustrating an REA based security system in which the security model with association classes uses the REA model semantic information, but exists outside the REA model itself.

FIG. 8-2 is a block diagram illustrating an REA based security system in which the security model with association classes is integrated into the REA model.

FIG. 9 is a block diagram illustrating a method of the present invention.

### DETAILED DESCRIPTION OF ILLUSTRATIVE EMBODIMENTS

The Resource-Event-Agent (REA) model allows for the modeling of “ownership” or “involvement”, but REA modeling semantics have not been used to drive security configurations. The present invention is based in part upon the recognition that REA modeling semantics can be used to provide such security. Disclosed is a strategy of using the REA semantics in driving default security configurations from any REA model incorporating these semantics. This strategy is used in the methods and apparatus of the present invention.

Traditional business applications separate security specifics from the domain or business application modeling. In contrast to the security implementing methods used in these traditional business applications, using the strategy disclosed herein, REA modeling techniques can be used to build security information into a domain or business solution. As used herein, the term “semantic model” refers to a computer software model of real-world activities, for example supply chain activities. A semantic model is rich in content and describes classes of objects, relationships, and functions involved in the real-world activities it models. The REA semantic model can be expressed in many formats: the extensible Markup Language (XML), the Universal Modeling Language (UML), a relational database, and/or an object oriented programming language. In the following discussions, security implementing improvements on the REA model are described primarily in terms of UML, but the present invention is not limited to UML implementations.

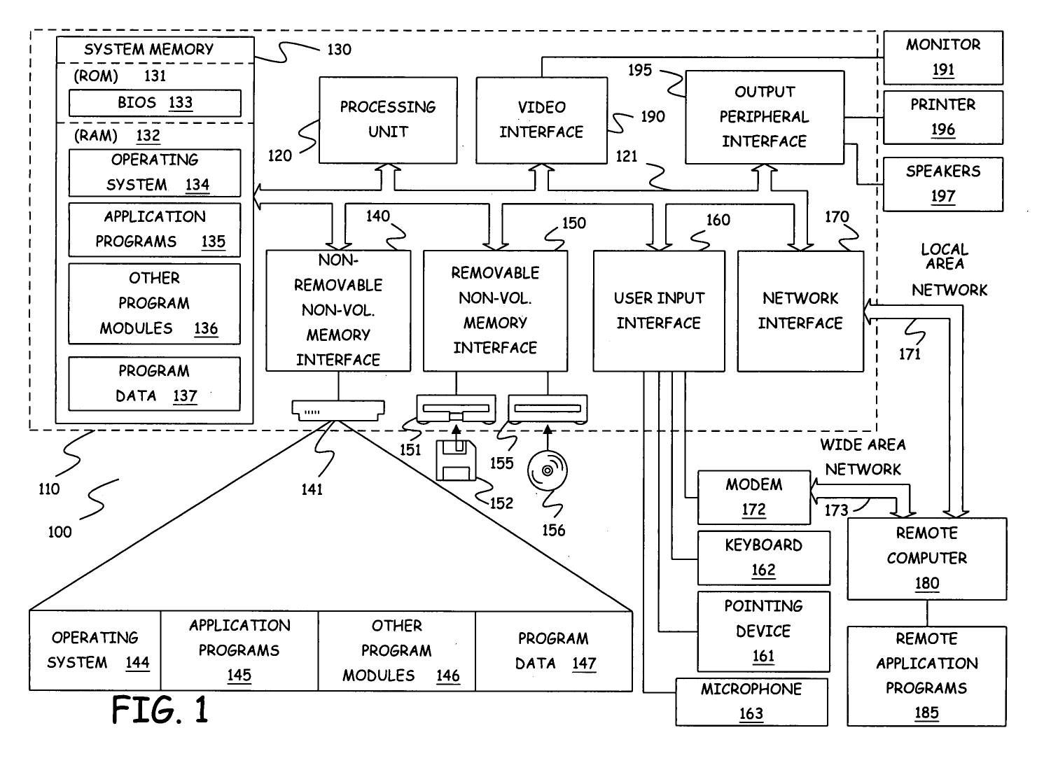

FIG. 1 illustrates an example of a suitable computing system environment 100 on which the invention may be implemented. The computing system environment 100 is only one example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN-networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

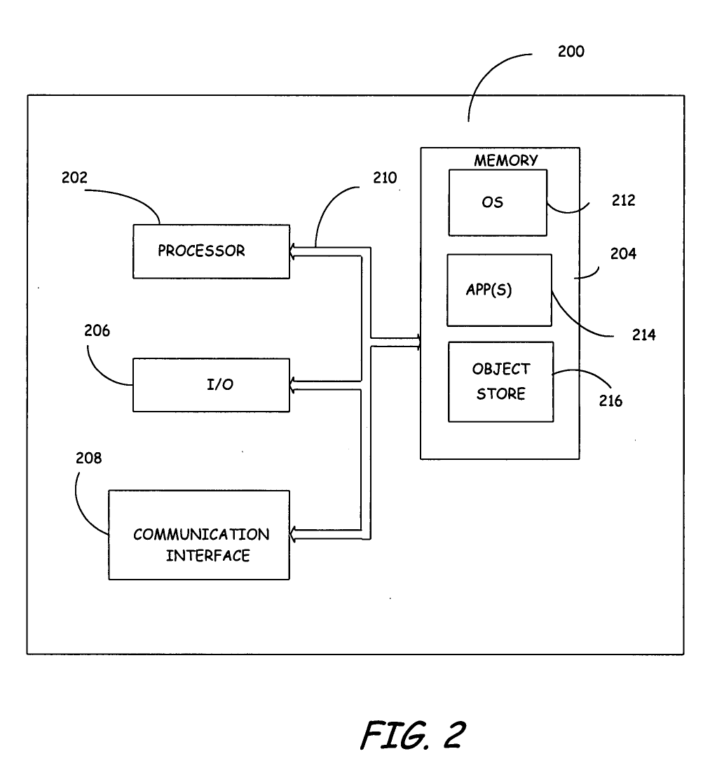

FIG. 2 is a block diagram of a mobile device 200, which is an alternative exemplary computing environment. Mobile device 200 includes a microprocessor 202, memory 204, input/output (I/O) components 206, and a communication interface 208 for communicating with remote computers or other mobile devices. In one embodiment, the afore-mentioned components are coupled for communication with one another over a suitable bus 210.

Memory 204 is implemented as non-volatile electronic memory such as random access memory (RAM) with a battery back-up module (not shown) such that information stored in memory 204 is not lost when the general power to mobile device 200 is shut down. A portion of memory 204 is preferably allocated as addressable memory for program execution, while another portion of memory 204 is preferably used for storage, such as to simulate storage on a disk drive.

Memory 204 includes an operating system 212, application programs 214 as well as an object store 216. During operation, operating system 212 is preferably executed by processor 202 from memory 204. Operating system 212, in one preferred embodiment, is a WINDOWS® CE brand operating system commercially available from Microsoft Corporation. Operating system 212 is preferably designed for mobile devices, and implements database features that can be utilized by applications 214 through a set of exposed application programming interfaces and methods. The objects in object store 216 are maintained by applications 214 and operating system 212, at least partially in response to calls to the exposed application programming interfaces and methods.

Communication interface 208 represents numerous devices and technologies that allow mobile device 200 to send and receive information. The devices include wired and wireless modems, satellite receivers and broadcast tuners to name a few. Mobile device 200 can also be directly connected to a computer to exchange data therewith. In such cases, communication interface 208 can be an infrared transceiver or a serial or parallel communication connection, all of which are capable of transmitting streaming information.

Input/output components 206 include a variety of input devices such as a touch-sensitive screen, buttons, rollers, and a microphone as well as a variety of output devices including an audio generator, a vibrating device, and a display. The devices listed above are by way of example and need not all be present on mobile device 200. In addition, other input/output devices may be attached to or found with mobile device 200.

Review of REA Modeling

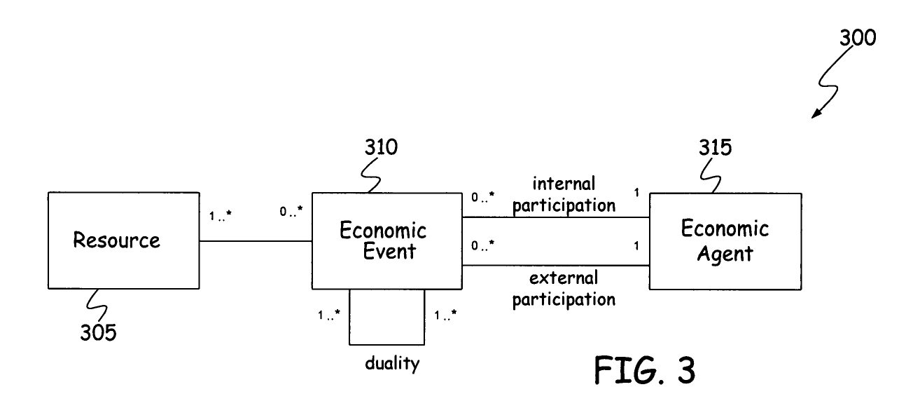

REA is an established modeling technique, ontology and semantic model for describing economic and business systems. REA describes a business system as a set of economic Resources, economic Events and economic Agents as well as relationships among them. Economic Events capture changes of ownership of economic Resources between economic Agents. FIG. 3 illustrates the basic REA metamodel 300, having Resources 305, Events 310 and Agents 315.

In the REA model, the exchanges of economic Resources are the primary economic data about the enterprise. Accounting artifacts such as debit, credit, journals, ledgers, receivables and accounts are derived from the data describing the exchanges. For example, the quantity on hand for an inventory item can be calculated as the imbalance between the Purchase Events and the Sale Events for that inventory item. In comparison, in most current Enterprise Resource Planning (ERP) systems it is opposite—the economic data is derived from the accounting artifacts. This, in some sense, puts the consequence before the cause and makes the model more complicated.

In addition, REA contains rules (axioms) assuring consistency of the model from an economic perspective. As the result: (1) The REA models are concise and easy to understand; (2) The same model is used across different business domains; (3) Accounting artifacts are always consistent, because they are derived from the same data (e.g., the same data describing the sales event is used in the warehouse management, payroll, distribution, finance and other modules); and (4) The REA model provides for more complete reporting than the reporting based on the accounting artifacts. Business Objects are always related together using a pattern of the general type illustrated in FIG. 3 and described below.

An “economic Resource” represents the subject of trade. An economic Resource is something of value that is under the control of the “economic Agent.” Examples of economic Resources are products, money, fixed assets, raw materials, and employee qualifications. Many other examples of Resources are also possible. Economic Resources represent the values which management seeks to control. An “economic Event” represents the change of ownership of an economic Resource. Some economic Events occur instantaneously, such as sales of goods. However, some occur over an interval of time, such as rentals or services and employment. Examples of economic Events include, but are not limited to, Shipment (delivery), Payment, Return of Goods, and usage of Employee time.

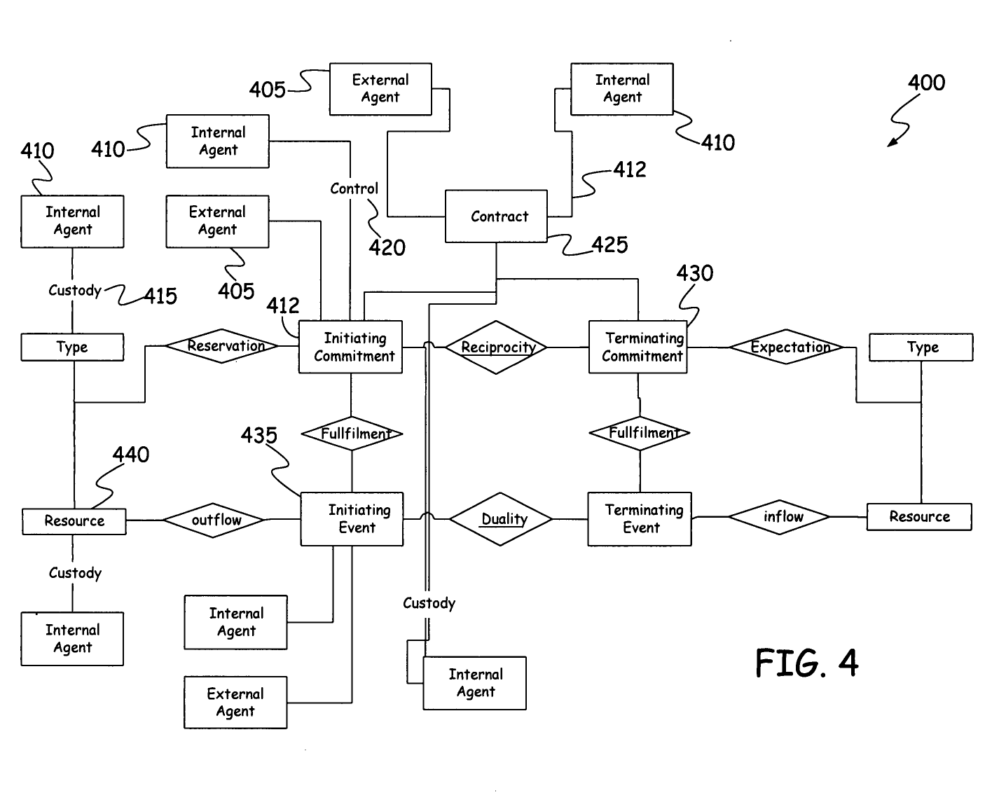

An “economic Agent” represents an economic unit, or legal entity capable of exchanging economic Resources (or just Resources) with other economic Agents (or just Agents). Examples of economic Agents include Customer, Vendor, and Employee. Agents are discussed in further detail with reference to FIG. 4. “Duality” is a relationship between economic Events. In REA, every economic Event representing inflow of Resources must be eventually related to an economic Event representing outflow of Resources, and vice versa.

Referring now to FIG. 4, shown is block diagram schematically illustrating a semantic REA model 400 with major Object types and Association types shown. A discussion of FIG. 4 is useful for further understanding terminology common to REA modeling. The present invention is not limited, however, to a system having the particular REA modeling elements shown in FIG. 4.

As shown in FIG. 4 and discussed with reference to FIG. 3, a typical REA model includes Resources, Agents and Events. Expanding on the above definitions using UML terminology, “Agents” can be defined as those who participate in Events. An “Agent” can also be defined as a Stereotype or a Categorization of a larger “Class” or “Class of Objects.” An “Object” is an “Instance” of a Class. For example, for a Class of Objects representing employees, engineer could be one Agent of the employee Class. An Object representing a particular engineer in the engineer Agent of the employee Class is an “Instance” of the employee Class. Generally, REA models support the notion that an Object represents a person, business, happening, etc. that is being modeled.

In FIG. 4, two types of Agents are illustrated, External Agents 405 and Internal Agents 410. In a common scenario, two Agents must be identified for an Event. The Agent who gives something (a “Resource”) up in the Event is the External Agent, and the Agent who receives something is the Internal Agent. The External Agent's participation in the Event is referred to as External Participation, while the Internal Agent's participation in the Event is referred to as Internal Participation.

As an example, for an REA model of an organization, an Outside Agent is often outside of the organization being modeled, such as a customer or vendor. An Inside Agent is often an employee of the organization. Which of the Inside and Outside Agents is the External Agent and which is the Internal Agent depends upon which is giving up a Resource in the Event. As a further example, if a transaction is a transfer of Resources between two business units within the organization being modeled, the Internal Agent will be the one giving up the Resource, while the External Agent will be the one receiving it. In the context of the present invention, External and Internal Agents are used to interpret application roles, with each unique External or Internal Agent translated into a new application role.

REA models support the notions of different kinds of relationships. The first type of relationship relates Objects of different types to form new Objects. This type of relationship is referred to as an “Association”. Associations are illustrated in FIG. 4 by arrow headed lines connecting Objects. One example Association is illustrated as designated by reference number 412.

“Control relationships” are Associations among an Agent on one side and an Economic Event or other type of Object, on the other side. For example, in FIG. 4, a “Control Association” type is illustrated, as designated by reference number 420, between an Internal Agent 410 and Initiating Commitment 412. Another example of a “Control Association” is between an External Agent 405 and Initiating Commitment 412. The example illustrates that an Internal Agent 410 will be held responsible (Control) for an Initiating Commitment 412 and the corresponding reservation of the Economic Resource 440. In the context of the present invention, a “Control Association” type is interpreted as “ownership” in relation to the Agent(s). When an Agent is at one end of an Association of type “Control,” in embodiments of the present invention the Agent will be granted rights on the Class of Objects at the other end. In FIG. 4, types of Objects illustrated with which an Agent may have the Control type Association include Contracts/Agreements 425, Commitments 430, Events 435, and Resources 440. A Control type Association can be had with other types of Objects as well.

Custody is another Association type. In the context of the present application, this Association type is interpreted as “responsibility”. When an Association between a Resource and an Agent (Internal or External) is of type Custody, in embodiments of the present invention the Agent will be granted some default permissions on the Resource. An example of a Custody type Association is illustrated in FIG. 4, between a Resource 440 and an Internal Agent 410, at reference number 415. In FIG. 4, types of Objects illustrated with which an Agent may have Custody include Contracts/Agreements 425, Commitments 430, and Events 435. A Custody type Association can be had with other types of Objects as well.

Security in REA Modeling

In accordance with embodiments of the present invention, an Association Class is added to the Association between an Agent and a corresponding securable Class. The Association Class is itself one or more new Objects. Each securable Class has a set of operations that can be performed on Instances of the Class. For example, these operations could be “read”, “update”, “delete”, “forward”, “print” or any other number of operations appropriate for the Class in question.

Security governing a particular relationship, an application or a system is often referred to as “Security Policy.” The Security Policy defines the model that describes all roles and securable Objects and their relationships. It further defines all operations that can be performed on each securable Object. This information makes up the static part of the model in a non-generic Object model. Other components such as users, permissions and other factors determining permission grants are dynamic and configurable. The remaining pieces of security components in a typical application are made up of tools and infrastructure to manage and enforce the policy.

The REA security strategy allows the generation of the static part of the Security Policy. With some additional policy capability such as a default configuration expressed in a policy template, the default dynamic configuration of the Security Policy can also be generated. After generating these static and dynamic portions of the Security Policy, in a typical application all that is left to do is to provide the system administrator some tools to manage the Security Policy after the application has been deployed.

To illustrate the concepts of the methods and apparatus of the present invention, portions of an REA model for a simple order entry application are shown and discussed. First consider the Role aspect of security. Role Based Access Control (RBAC) is a technology/strategy commonly used in business applications. In such a model, users have roles and roles have permissions. A role corresponds to a job function in an organization. Conceptually and practically it is easier to manage security permissions for a person when the person's job function is known rather than through the use of other grouping mechanisms not related to job function.

In accordance with aspects of the present invention, in an REA model, a first step in the REA security strategy is to implement the following. For all unique classes stereotyped with the <<Agent>> moniker, a new security role is created. The role can be granted permissions to perform operations on Objects represented with relationships to the role's representative Agent Class in the model. One example of this is depicted in the diagrams provided in FIGS. 5-1 and 5-2.

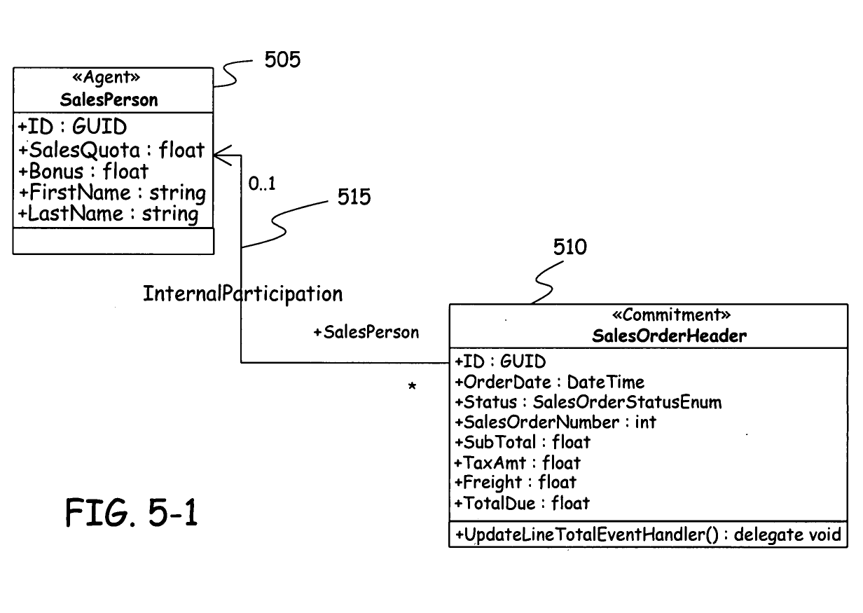

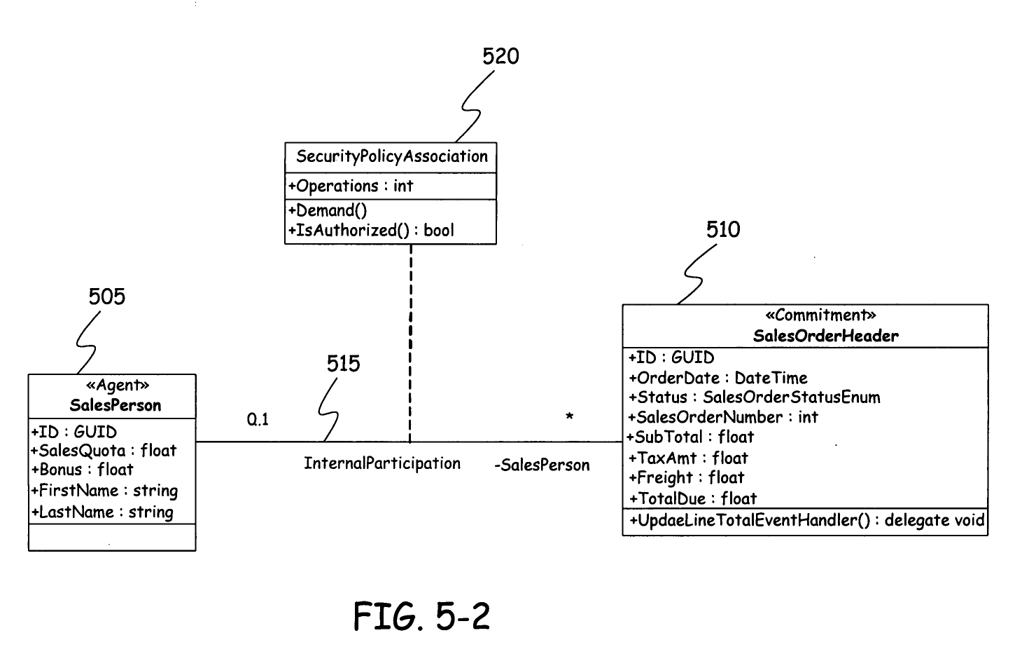

Shown in FIG. 5-1 is an object 505 representing a “SalesPerson” marked with the Agent stereotype. Also shown is a second object 510 representing a “SalesOrderHeader” type Commitment. An Internal Participation type Association exists between the SalesPerson Agent and the SalesOrderHeader Commitment, as is shown by reference number 515.

In this example the “SalesPerson” marked with the <<Agent>> stereotype becomes a security role. Every other unique Agent in the model also will become security roles to be used in the RBAC implementation. Each of these roles is then analyzed to establish which relationships they have to other classes in the model and for what kind of relationships they have to these classes.

Shown in FIG. 5-2 is the same diagram illustrated in FIG. 5-1, but including an Association Class 520 in accordance with the invention. Association Class 520 is an Object (or Objects) used to implement the Security Policy. The Object 520 entitled “SecurityPolicyAssociation” is an Association Class on the Association 515 between the Commitment (SalesOrderHeader) 510 and the Agent (SalesPerson) 505. The Association Class 520 contains as properties or data fields information indicative of the operations that the Agent 505 can perform on the Commitment 510, thus providing security in the REA model. The list of operations could be different of course depending on the Commitment type. Commonly the operation set includes operations such as “Create”, “Read”, “Update”, “Delete” (CRUD).

When a sales order is created, the SecurityPolicyAssociation Class can contain a template policy that specifies which operations by default are granted to the Agent. Since this is an InternalParticipation Association of type Control, the SalesPerson in question (represented by Object 505) could be awarded full access rights (CRU), with the potential exception of “Delete”. The right to “Delete” the Sales Order Object 510 might be a reserved operation for another Agent. Either way, with the improvements of the present invention in the form of the addition of an Association Class to define the operations that the Agent 505 can perform on the Commitment 510, the REA model can be used to derive automatic security settings based on the existing REA semantics.

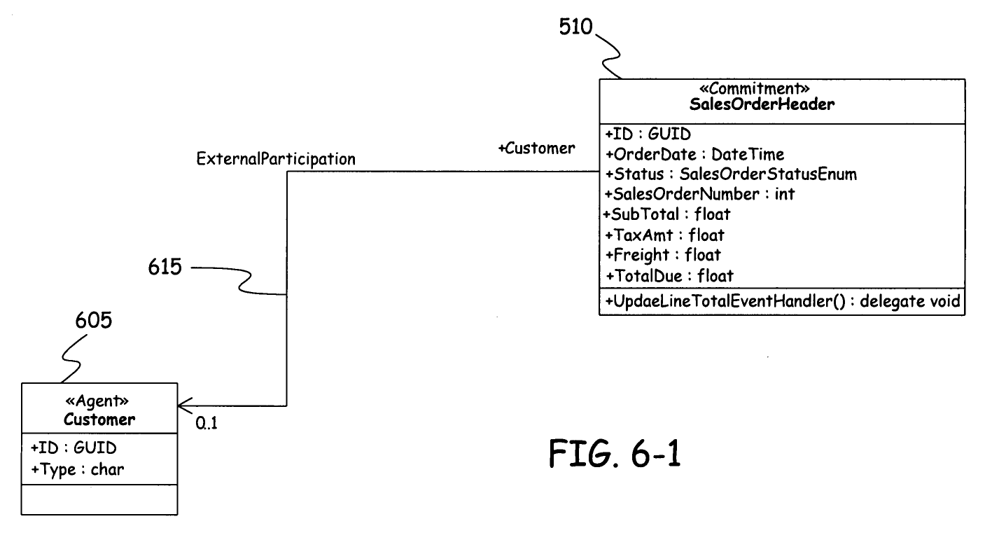

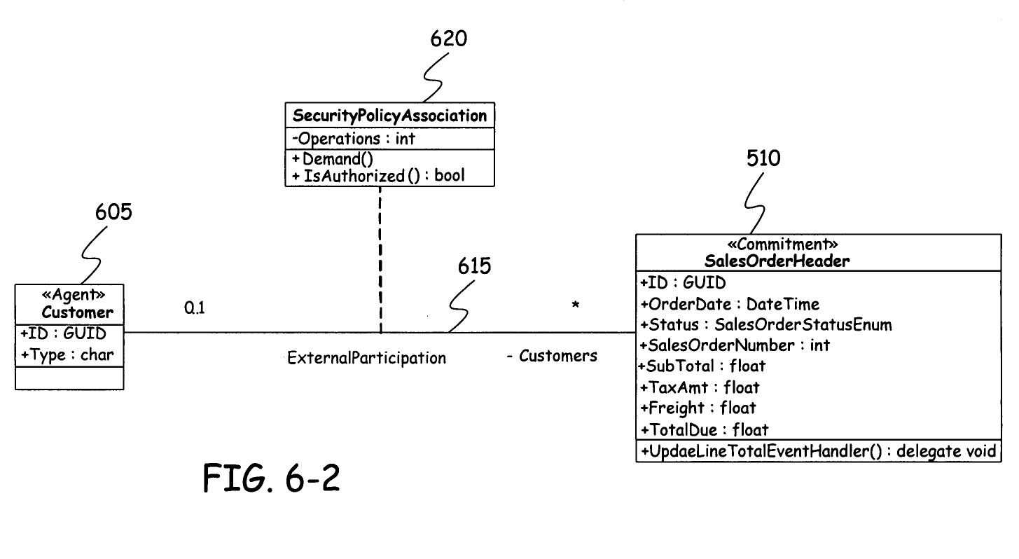

FIG. 6-1 is a diagram illustrating another Agent with a relationship to the SalesOrderHeader Class Objects. In FIG. 6-1, an Object 605 representing a “Customer” marked with the Agent stereotype is shown. An external participation type Association exists between the Customer Agent 605 and the SalesOrderHeader Commitment 510, as shown at reference number 615. In this example, the Customer is the Agent with the External Participation Association with Control type. The “Customer” Agent Class is another role instance in this REA model. As was the case with the example provided in FIGS. 5-1 and 5-2, security is provided to the REA model by creating another Association Class of Objects on the Association 615 between the two Objects (or Object Classes) 510 and 605.

Referring now to FIG. 6-2, shown is an Association Class 620 on the Association 615 between Objects 605 and 510. Again the same strategy is used to provide security to the REA model, with security defined or controlled by the Association Class Object(s) marked as “SecurityPolicyAssociation,” but there is a slight difference on default rights for the Customer Agent with Association marked as External Participation. In REA, the Agent on the external side is the one with less authority in the relationship. In practice, in business environments, the customer typically has all the authority, thus the commonly used phrase “the customer is always right.” This type of authority is of course not what is referred to when it is said that the Customer Agent has “less authority.” Instead, the point being made is that the Sales Person creates the sales order; she enters information and ensures someone ships it to the Customer. In this process the Sales Person receives significant permissions to work the sales order through the process. The Customer in this case might just need permission to read the SalesOrderHeader, for the purpose of checking order status. If such generalizations are made, it can be concluded that the Agent with External Participation will always be the Agent with the lesser privileges as opposed to the Internally Participating Agent.

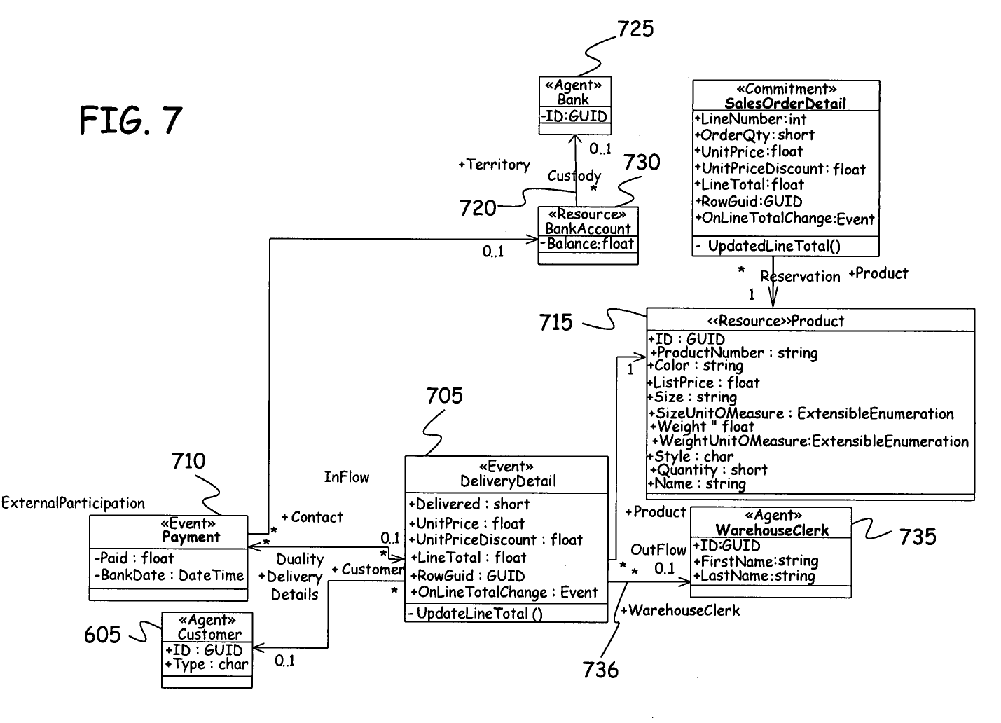

Consider now the diagram illustrated in FIG. 7 in which a larger portion of a model is represented. In this small sample of a larger model, attention is drawn to the fact that Event and Product Objects are involved (see for example Objects 705, 710 and 715). Also shown is a “Custody” Association type 720 between an Object 725, representing a “Bank” marked with the Agent stereotype, and an Object 730 representing a Resource of type “BankAccount.”

Also added in FIG. 7 is the Object 735 representing a “WareHouseClerk” marked with the Agent stereotype. The WareHouseClerk Object 735 has an Association 736 with the Object 705 representing the “DeliveryDetail” Event. In this case the WarehouseClerk 735 is working in the order fulfillment process between when the Event 705 initiated and when it will stop. Since there is a customer involved here (Customer Agent 605) that will receive goods (Product Resource 715), the rights that customer has on any of his orders will “increase in importance” after the payment has been made. This “transitional” effect is there for Events, and one can envision Objects and Agents where the Agent has no rights on an Object before an Event is initiated, limited access rights during a certain state of the Object and finally back to no rights once the Event has passed. This type of dynamic permission grant is possible because of the rich semantics of the REA model, plus the added Security Policy Association Classes of the present invention (illustrated in FIGS. 5-2 and 6-2).

It must be noted that an agent can act on behalf of other agents. This relationship, often referred to as impersonation, gives the impersonator the rights of the impersonated agent. For example, an ambassador is impersonating the head of state in a foreign country, giving the ambassador the access rights of the head of state towards the objects related to the ambassador (the impersonator).

The “Custody” association class is representative of “Responsibility”, so a similar security strategy can be devised by applying the Association Class inventive aspects discussed above, adding permissions to operations into the Association Class Object(s).

From these examples, it can be seen that, using this REA Security strategy to model very important meta data, a security subsystem can be provided which can be used both at administrative and run times. As in the case of the dynamic aspect of administering and enforcing security on REA events, it is in some cases a benefit to abstract some of the decision making into a separate model and a set of business logic. This can be accomplished using a policy object or subsystem.

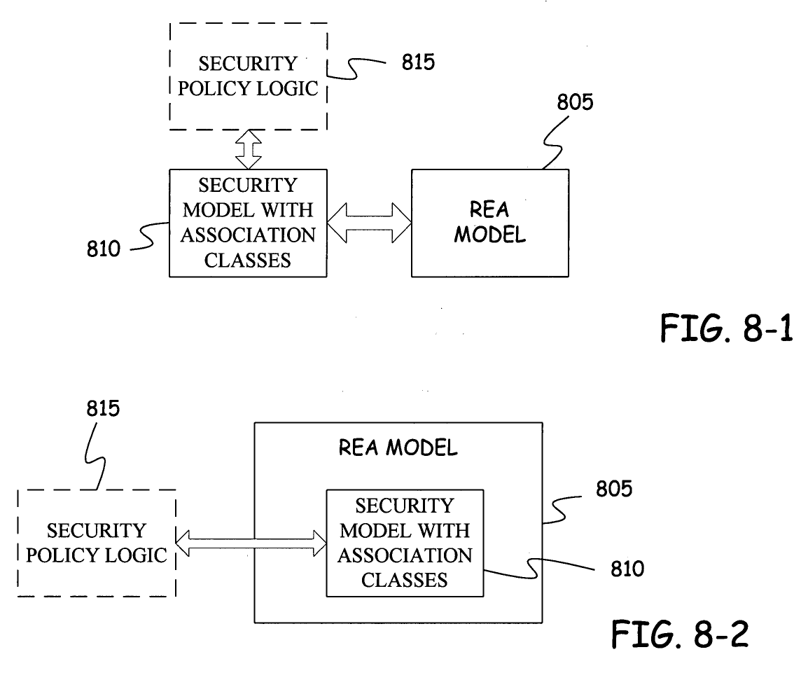

In some embodiments, the Security Policy is a separate model parallel to the REA model, while the REA model contains all the information the developer can possibly know during design such as the who (roles) and the what (securable Objects+possible operations on those Objects). An example of such a system is illustrated in FIG. 8-1 in which a security model 810 with Association Classes in accordance with the present invention is separate from REA model 805. The Security Policy implemented by the security model 810 contains information that can only be known or can be modified at or after deployment. “Users” is an example of information that can be added in deployment of the separate Security Policy model 810 including the Security Policy Association Class of the present invention. Also shown is an optional security policy logic module 815 which abstracts some of the decision making into a separate model and a set of business logic. For example, if the security model 810 includes Association Classes which grants rights to certain users for certain resources, the security policy logic module 815 can be used to define those rights if they are dynamic in nature (i.e., depending upon dates or times, depending upon the status of an Event, etc). References to models or modules are intended to include suitably programmed processing components and/or systems, as well as associated memory, for example such as those shown in FIGS. 1 and 2.

In alternate embodiments, one could add “Users” to the REA model itself, but this may not be preferred. However, such an embodiment is within the scope of the invention, and is illustrated in FIG. 8-2 in which a security model 810 with Association Classes in accordance with the present invention is integrated with REA model 805. Thus, the Association Class Objects which define the security policy are added to the REA model itself.

Again, with security policy logic module 815, answers provided by the Security Policy which are in the when category (e.g., when does the permission apply?) can be generated separately from models 805/810. If requirements exist for allowing a certain set of permissions to be active during regular work hours, and a different set of permissions after hours or on weekends, a separate policy logic system or module 815 can be used, in conjunction with the Security Policy Model 810 having the Security Policy Association Class, where decisions on active policy are made based on different evidence types. Examples of evidence types include time, location, etc.

Another area of importance when it comes to deployment flexibility is how to handle various forms of privacy legislation. Many companies often are at a loss when it comes to adopting their applications to use different privacy policies depending on where they have been deployed. The REA Security strategy plus the external policy ideas will help.

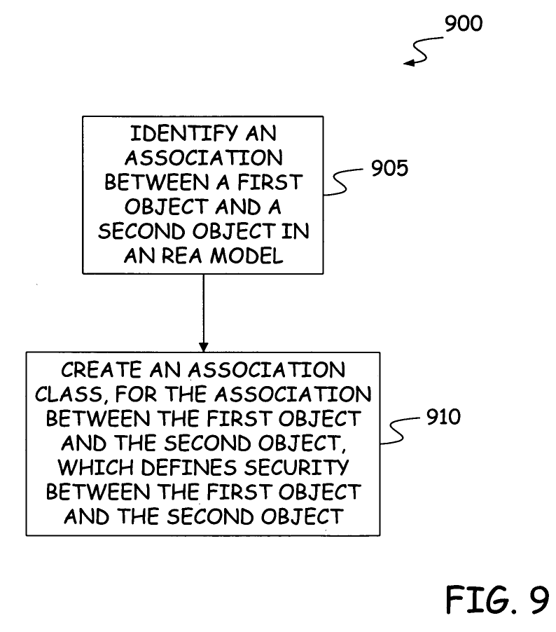

FIG. 9 is a block diagram 900 illustrating a method of providing Resource-Event-Agent (REA) model based security. The method illustrated in FIG. 9 summarizes the methodology disclosed above, but does not limit the present invention to this particular method. As shown at block 905, the method includes identifying an association between a first object and a second object in an REA model. Then, as shown at block 910, an association class is created for the association between the first object and the second object. The association class, for example called a Security Policy Association Class, defines security between the first object and the second object.

The association class, defined between the first object and the second object, is an object having properties. The properties of the association class object define the security between the first object and the second object. The step of creating the association class can further comprise creating one or more association class objects having properties, with the properties of the one or more association class objects defining security between a first class of objects of which the first object is a member and a second class of objects of which the second object is a member. The second object is a securable object, such as a contract or agreement type object, a commitment type object, an event type object, or a resource type object. The first object is of a particular agent type. A role for a user is defined by the particular agent type for the first object.

The association class created between the first object and the second object can be created in a security model either separate from the REA model, or as part of the REA model. The security defined between the first object and the second object includes defining permissions and rights of the first object relative to the second object. These permissions and rights can be determined dynamically in a security policy logic module outside of the security model. This is particularly useful for permissions and rights which are transient in nature, for example depending upon the date, time, status of an event, etc.

Although the present invention has been described with reference to particular embodiments, workers skilled in the art will recognize that changes may be made in form and detail without departing from the spirit and scope of the invention.

1. A method of providing Resource-Event-Agent (REA) model based security, the method comprising:
identifying an association between a first object and a second object in an REA model;
creating an association class object for the association between the first object and the second object, the association class object having properties defining security between the first object and the second object.

2. (canceled)

3. The method of claim 1, wherein creating the association class object further comprises creating one or more association class objects having properties, the properties of the one or more association class objects defining security between a first class of objects of which the first object is a member and a second class of objects of which the second object is a member.

4. The method of claim 1, wherein the second object is a securable object.

5. The method of claim 4, wherein the first object is of a particular agent type, and wherein a role for a user is defined by the particular agent type for the first object.

6. The method of claim 5, wherein the second object is a contract or agreement type object.

7. The method of claim 5, wherein the second object is a commitment type object.

8. The method of claim 5, wherein the second object is an event type object.

9. The method of claim 5, wherein the second object is a resource type object.

10. The method of claim 5, wherein the second object is an agent type object.

11. The method of claim 5, wherein identifying the association between the first object and the second object further comprises identifying a control type association between the first object and the second object.

12. The method of claim 5, wherein identifying the association between the first object and the second object further comprises identifying a custody type association between the first object and the second object.

13. The method of claim 5, wherein creating the association class object for the association between the first object and the second object further comprises creating the association class object in a security model.

14. The method of claim 13, wherein creating the association class object in the security model further comprises creating the association class object in the security model separate from the REA model.

15. The method of claim 13, wherein creating the association class object in the security model further comprises creating the association class object in the security model as part of the REA model.

16. The method of claim 13, wherein defining security between the first object and the second object further comprises defining permissions and rights of the first object relative to the second object.

17. The method of claim 16, wherein defining permissions and rights of the first object relative to the second object further comprises dynamically determining the permissions and rights in a security policy logic module outside of the security model.

18. A computer readable medium having computer-executable instructions for performing steps of a method of providing Resource-Event-Agent (REA) model based security, the steps comprising:
identifying an association between a first object and a second object in all REA model;
creating an association class object for the association between the first object and the second object, the association class object having properties defining security between the first object and the second object.

19. (canceled)

20. The computer readable medium of claim 18, wherein creating the association class object further comprises creating one or more association class objects having properties, the properties of the one or more association class objects defining security between a first class of objects of which the first object is a member and a second class of objects of which the second object is a member.

21. The computer readable medium of claim 18, wherein the first object is of a particular agent type, and wherein a role for a user is defined by the particular agent type for the first object.

22. The computer readable medium of claim 21, wherein the second object is a contract or agreement type object.

23. The computer readable medium of claim 21, wherein the second object is a commitment type object.

24. The computer readable medium of claim 21, wherein the second object is an event type object.

25. The computer readable medium of claim 21, wherein the second object is a resource type object.

26. The computer readable medium of claim 21, wherein the second object is an agent type object.

27. The computer readable medium of claim 18, wherein identifying the association between the first object and the second object further comprises identifying a control type association between the first object and the second object.

28. The computer readable medium of claim 18, wherein identifying the association between the first object and the second object further comprises identifying a custody type association between the first object and the second object.

29. The computer readable medium of claim 18, wherein creating the association class object for the association between the first object and the second object further comprises creating the association class object in a security model.

30. The computer readable medium of claim 29, wherein creating the association class object in the security model further comprises creating the association class object in the security model separate from the REA model.

31. The computer readable medium of claim 29, wherein creating the association class object in the security model further comprises creating the association class object in the security model as part of the REA model.

32. The computer readable medium of claim 29, wherein defining security between the first object and the second object further comprises defining permissions and rights of the first object relative to the second object.

33. The computer readable medium of claim 32, wherein defining permissions and rights of the first object relative to the second object further comprises dynamically determining the permissions and rights in a security policy logic module outside of the security model.

34. A system for providing security, the system comprising:
a Resource-Event-Agent (REA) model configured to implement a first object, a second object, and an association between the first object and the second object;
a security model configured to implement an association class object for the association between the first object and the second object in the REA model, such that properties of the association class object defines security between the first object and the second object.

35. (canceled)

36. The system of claim 34, wherein the association class object further comprises one or more association class objects having properties, the properties of the one or more association class objects defining security between a first class of objects of which the first object is a member and a second class of objects of which the second object is a member.

37. The system of claim 34, wherein the security model is separate from the REA model.

38. The system of claim 34, wherein the security model is part of the REA model.

39. The system of claim 34, and further comprising a security policy logic module coupled to the security model and configured to dynamically determine permissions and rights of the first object relative to the second object.
